(19) United States
(12) Patent Application Publication
(10) Pub. No.: US 2009/0196202 A1
(43) Pub. Date: Aug. 6, 2009

(54) TRANSMITTING APPARATUS AND PATH SETTING METHOD

(75) Inventors: Yasuki FUJII, Kawasaki (JP); Shinya KANO, Kawasaki (JP); Yuji TOCHIO, Kawasaki (JP); Kazuyuki TAJIMA, Kawasaki (JP); Keiji MIYAZAKI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/366,436

(22) Filed: Feb. 5, 2009

(30) Foreign Application Priority Data
Feb. 5, 2008 (JP) 2008-025695

(51) Int. Cl. H04L 12/28; H04L 12/56

(52) U.S. Cl. 370/254; 370/400

(57) ABSTRACT

A transmitting apparatus in a network constituted of a plurality of rings connected via a plurality of routes includes a node type determining unit and a backup path setting message transmitting unit. The node type determining unit determines, on receipt of a working path setting message requesting to set a working path, whether the transmitting apparatus is any one of a branch node at which a backup path is branched off from the working path or a merge node at which the backup path merges into the working path. The backup path setting message transmitting unit transmits, when the transmitting apparatus is determined to be a branch node or a merge node, a backup path setting message specifying a route from a ring including the transmitting apparatus to a connection node connecting the ring and a neighboring ring.

### BACKGROUND OF THE INVENTION

1. Field of the Invention

The embodiments discussed herein are directed to a technology for setting a path in a network constituted of a plurality of rings.

2. Description of the Related Art

In a SONET/SDH (Synchronous Optical NETwork/Synchronous Digital Hierarchy) network, RSVP-TE (Resource reSerVation Protocol-Traffic Engineering, RFC3473) extension of GMPLS (Generalized Multi-Protocol Label Switching) is well-known for setting a path by signaling.

A conventional technology is disclosed in Japanese Laid-open Patent Publication No. 2007-28386 in which RSVP-TE is further extended and a backup path of rings can be autonomously set simultaneously. With the conventional technology, a backup path can be autonomously set among a plurality of rings connected via a plurality of routes. As a result, even if a failure occurs on one of the routes, communication can continue by using a backup path set along another route.

In the conventional technology, however, each transmitting apparatus constituting a ring needs large amount of information for autonomously setting a backup path. More specifically, each transmitting apparatus needs configuration information of neighboring rings in addition to that of the local ring to autonomously set a route reaching a neighboring ring via a route between the local ring and the neighboring ring. Therefore, a burden on an administrator who manages information increases, and also a large amount of memory is required.

### SUMMARY

It is an object of the present invention to at least partially solve the problems in the conventional technology.

According to an aspect of the present invention, there is provided a transmitting apparatus in a network that is constituted of a plurality of rings connected via a plurality of routes. The transmitting apparatus includes: a node type determining unit that determines, on receipt of a working path setting message requesting to set a working path, whether the transmitting apparatus is any one of a branch node at which a backup path is branched off from the working path and a merge node at which the backup path merges into the working path, the backup path having a route other than a route of the working path that connects rings; and a backup path setting message transmitting unit that transmits, when the node type determining unit determines that the transmitting apparatus is any one of a branch node and a merge node, a backup path setting message specifying a route from a local ring including the transmitting apparatus to a connection node connecting the local ring and a neighboring ring.

According to another aspect of the present invention, there is provided a path setting method applied to a transmitting apparatus in a network that is constituted of a plurality of rings connected via a plurality of routes. The path setting method includes: determining, on receipt of a working path setting message requesting to set a working path, whether the transmitting apparatus is any one of a branch node at which a backup path is branched off from the working path and a merge node at which the backup path merges into the working path, the backup path having a route other than a route of the working path that connects rings; and transmitting, when the transmitting apparatus is determined to be any one of a branch node and a merge node at the determining, a backup path setting message specifying a route from a local ring including the transmitting apparatus to a connection node connecting the local ring and a neighboring ring.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a transmitting apparatus according to an embodiment of the present invention;

FIG. 2 is an example of local ring configuration information depicted in FIG. 1;

FIG. 3 is an example of inter-ring connection information depicted in FIG. 1;

FIG. 4 is a flowchart of a path setting process performed by the transmitting apparatus;

FIG. 5 is a detailed flowchart of a working path setting process in FIG. 4;

FIG. 6 is a detailed flowchart of a branch node determining process in FIG. 5;

FIG. 7 is a detailed flowchart of a merge node determining process in FIG. 5;

FIG. 8 is a detailed flowchart of a backup path setting process in FIG. 4;

FIG. 9 is an example of working path setting and backup path setting;

FIG. 10 is an example of path setting when another route is set as a backup path by evaluating cost;

FIGS. 11 and 12 are examples of backup path settings when a different path is used as a working path; and

FIG. 13 is an example of rings connected via a plurality of routes.

### DETAILED DESCRIPTION OF THE PREFERRED EMBODIMENTS

Exemplary embodiments of the present invention are described in detail below with reference to the accompanying drawings.

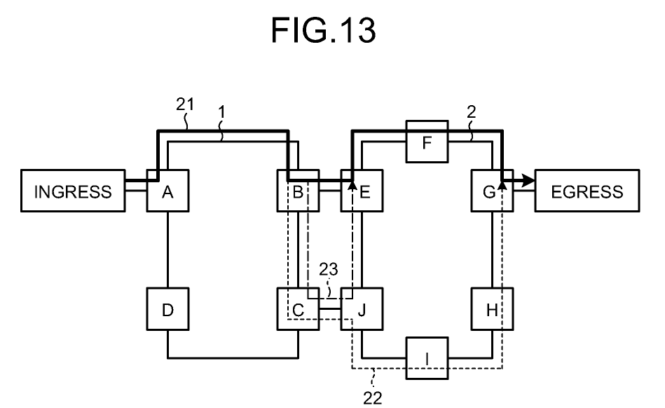

A description is given first of rings connected to each other via a plurality of routes. FIG. 13 is an example of rings connected to each other via a plurality of routes. A network illustrated in FIG. 13 includes a ring 1 including nodes A to D and a ring 2 including nodes E to J. Connection between the rings 1 and 2 is established by a route between the nodes B and E and by a route between the nodes C and J. The rings 1 and 2 are, for example, bidirectional line switched ring (BLSR) rings of SONET/SDH.

Assuming that a working path 21 “A-B-E-F-G” is set between Ingress connected to the ring 1 and Egress connected to the ring 2, segments “A-B” and “E-F-G” are protected by BLSR ring protection. A segment “B-E” that constitutes a connection section between the rings 1 and 2, however, is not protected. Therefore, if a communication failure occurs at the segment “B-E”, the communication between Ingress and Egress is lost.

Therefore, a backup path using another route between the rings 1 and 2, for example, a backup path 22 “B-C-J-I-H-G” or a backup path 23 “B-C-J-E” is set. When the backup path 22 or 23 is set therebetween, even if a communication failure occurs at the segment “B-E”, communication between Ingress and Egress can continue using the route “C-J”. In setting a backup path, a node at which a backup path is branched off from a working path like the node B is referred to as a branch node, and a node at which a working path and a backup path merge into each other like the nodes E and G is referred to as a merge node.

A configuration of a transmitting apparatus 10 according to an embodiment is described in detail below. The transmitting apparatus 10 is a communication apparatus such as the nodes A to J depicted in FIG. 13 constituting a ring. The transmitting apparatus 10 has a typical function for forming a ring, and in addition, also has a function for autonomously setting a backup path between rings connected to each other via a plurality of routes. In the descriptions below, the transmitting apparatus 10 constituting a network is simply referred to as a “node”.

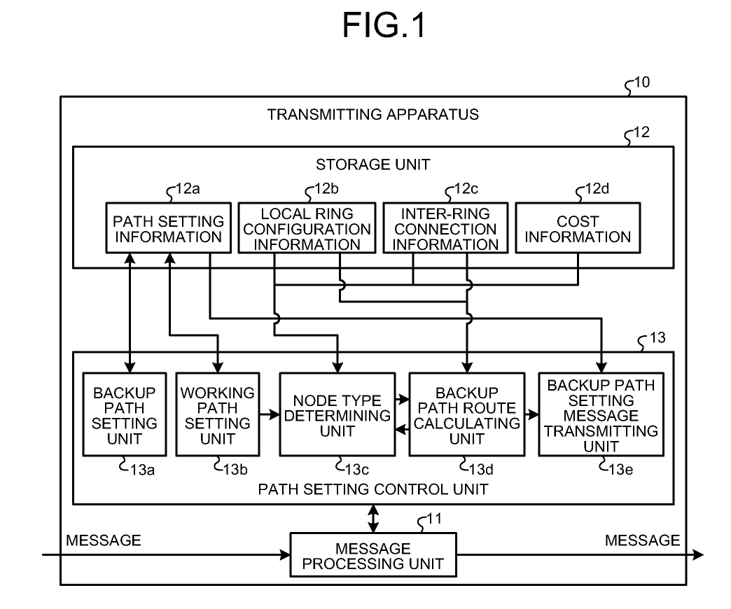

FIG. 1 is a functional block diagram of the transmitting apparatus 10 according to the present embodiment. As depicted in FIG. 1, the transmitting apparatus 10 includes a message processing unit 11, a storage unit 12, and a path setting control unit 13. The message processing unit 11 transmits a message according to path setting. More specifically, the message processing unit 11, for example, transmits a message received from another neighboring node to still another node or to an external network, or transmits a message received from an external network to another neighboring node.

The storage unit 12 stores various information necessary for the operation of the transmitting apparatus 10. The storage unit 12 stores therein path setting information 12a, local ring configuration information 12b, inter-ring connection information 12c, and cost information 12d. The path setting information 12a is information about paths that are already set. The information is used, for example, for searching for a vacant channel when setting a new path.

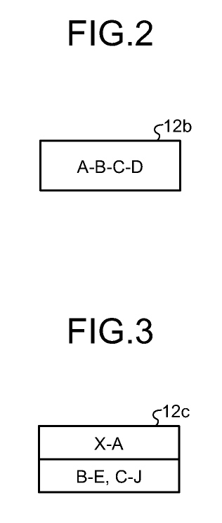

The local ring configuration information 12b is information about nodes that constitute a local ring. The term “local ring” as used herein refers to a ring including the node itself (hereinafter, referred to as “local node”). An example of the local ring configuration information 12b is depicted in FIG. 2. The example of the local ring configuration information 12b depicted in FIG. 2 indicates that the ring including the local node is formed such that the nodes A, B, C, and D are connected sequentially in the described order.

The inter-ring connection information 12c is information on via which route the ring including the local node is connected to other rings. An example of the inter-ring connection information 12c is depicted in FIG. 3. The example of inter-ring connection information 12c depicted in FIG. 3 indicates that the ring including the local node is connected to a neighboring ring via a route between nodes X and A, as well as the ring including the local node is connected to another neighboring ring via two routes one of which is a route between the nodes B and E and the other of which is a route between the nodes C and J.

The local ring configuration information 12b and the inter-ring connection information 12c may be configured so that each piece of the information is input manually by an administrator, each piece of the information is provided, for example, from an NMS (Network Management System), or each piece of the information is obtained from information advertised by some protocol.

The cost information 12d is information about communication cost between nodes. More specifically, the cost information 12d includes information such as bandwidth and distance between nodes.

The path setting control unit 13 is a control unit that performs various control operations regarding path setting. The path setting control unit 13 includes a backup path setting unit 13a, a working path setting unit 13b, a node type determining unit 13c, a backup path route calculating unit 13d, and a backup path setting message transmitting unit 13e.

When a backup path setting message is sent to the local node requesting to set a backup path, the backup path setting unit 13a sets a backup path by controlling, for example, switches in the message processing unit 11 according to the backup path setting message. If the local node is not a terminal node in a backup path specified by the backup path setting message, the backup path setting unit 13a transfers the backup path setting message to a next node. If the local node is a terminal node in a backup path specified by the backup path setting message, the backup path setting unit 13a searches with reference to the path setting information 12a for another backup path for the same working path. If a suitable backup path is found, the backup path setting unit 13a connects the found backup path to a backup path that is requested to set by the backup path setting message. Then the backup path setting unit 13a adds to the path setting information 12a information about the backup path thus set.

When a working path setting message is sent to the local node requesting to set a working path, the working path setting unit 13b sets a working path by controlling, for example, switches in the message processing unit 11 according to the working path setting message. If the local node is not a terminal node in a working path specified by the working path setting message, the working path setting unit 13b transfers the working path setting message to a next node. Then the working path setting unit 13b adds to the path setting information 12a information about the working path thus set.

The node type determining unit 13c determines whether the local node is a branch node or a merge node according to, for example, restriction due to the specification of a ring. As a result of the determination, if it is determined that another node can be a branch node in addition to the local node, the node type determining unit 13c refers to the cost information 12d and determines that a node that makes the cost of the backup path lower to be a branch node.

If a hop count up to a connection node described in detail below, or the number of nodes that the backup path passes through until the backup path reaches the connection node, is used as a cost, the cost information 12d is unnecessary because the hop count can be obtained by referring to the local ring configuration information 12b and to the inter-ring connection information 12c. A route reaching the connection node can be obtained from the backup path route calculating unit 13d.

If the node type determining unit 13c determines that the local node is a branch node or a merge node, the backup path route calculating unit 13d decides a route of a backup path. The backup path route calculating unit 13d does not always decide a route of a backup path so that the branch node and the merge node are directly connected to each other. The backup path route calculating unit 13d decides only a route of a backup path between the local node and the connection node.

The connection node is a node at which a backup path that is set in the forward direction from the side of the branch node and a backup path that is set in the reverse direction from the side of the merge node are connected to each other. More specifically, among the nodes that connect the rings, a node at which the working path is not added on the side of the merge node or a node at which the working path is not dropped on the side of the branch node is a connection node.

Assuming that the two paths reaching the connection node are connected together to set a backup path, either the branch node or the merge node does not have to store detailed configuration information of neighboring rings, as well as a route of a backup path can be autonomously decided according to the local ring configuration information 12b and the inter-ring connection information 12c. Then, the amount of memory that stores configuration information of the rings therein can be less and the number of man-hour of the administrator who manages various information can be also reduced. In the present embodiment, a node on the ring of the side of the merge node may be a connection node.

The backup path setting message transmitting unit 13e generates a backup path setting message for setting a backup path according to a route decided by the backup path route calculating unit 13d and transmits the same. More specifically, if the node type determining unit 13c determines that the local node is a branch node, the backup path setting message transmitting unit 13e generates a backup path setting message requesting to set a backup path in the forward direction, or a backup path of which the starting point is the local node and of which the terminating point is the connection node, and transmits the same. If the node type determining unit 13c determines that the local node is a merge node, the backup path setting message transmitting unit 13e generates a backup path setting message requesting to set a backup path in the reverse direction, or a backup path of which the starting point is the local node and of which the terminal point is the connection node, and transmits the same.

The backup path setting message transmitting unit 13e adds information for recognizing a corresponding working path to the backup path setting message that is sent by the backup path setting message transmitting unit 13e so that the connection node can connect the two backup paths. The information for recognizing a corresponding working path may be something like an identification number of a working path or route information thereof.

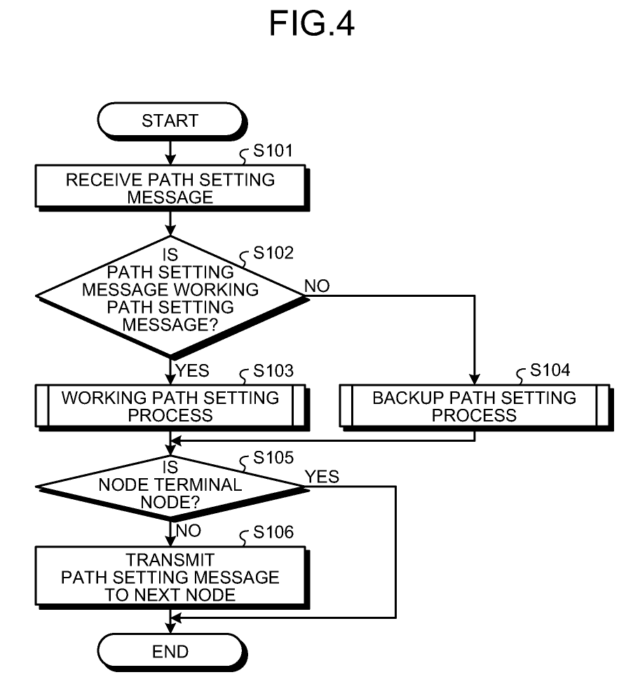

The operation of the transmitting apparatus 10 according to the present embodiment is described in detail below. FIG. 4 is a flowchart of a path setting process performed by the transmitting apparatus 10 according to the present embodiment. The transmitting apparatus 10 performs the path setting process each time it receives a path setting message.

As depicted in FIG. 4, the transmitting apparatus 10 receives a path setting message (Step S101). If the path setting message is a working path setting message (YES at Step S102), the transmitting apparatus 10 performs a working path setting process described in detail below (Step S103). If the path setting message is a backup path setting message (NO at Step S102), the transmitting apparatus 10 performs a backup path setting process described in detail below (Step S104). If the local node is not a terminal node in a path specified by the path setting message (NO at Step 105), the transmitting apparatus 10 transmits the path setting message to a next node (Step S106).

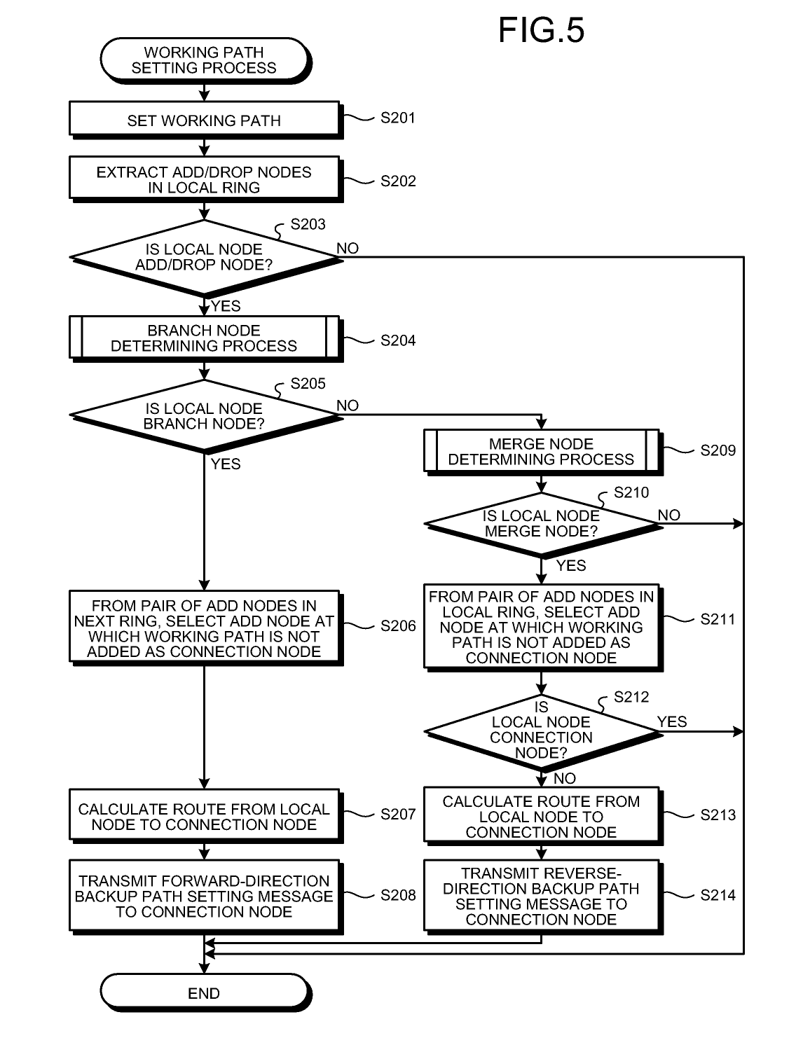

FIG. 5 is a detailed flowchart of the working path setting process. As depicted in FIG. 5, when the transmitting apparatus 10 receives a working setting message, the working path setting unit 13b sets a working path in a conventional manner (Step S201). Then, the node type determining unit 13c refers to the local ring configuration information 12b and the inter-ring connection information 12c, and extracts add nodes and drop nodes in the local ring (Step S202). For example, in the case of the local ring configuration information 12b and the inter-ring connection information 12c depicted in FIGS. 2 and 3, the nodes A and B included in both the local ring configuration information 12b and the inter-ring connection information 12c are extracted as add nodes, and the node C included in both the local ring configuration information 12b and the inter-ring connection information 12c is extracted as a drop node.

If the local node is neither an add node nor a drop node (NO at Step S203), the working path setting process is terminated without setting a backup path. If the local node is an add node or a drop node (YES at Step S203), the node type determining unit 13c performs a branch node determining process described in below and determines whether the local node is a branch node (Step S204).

If the local node is a branch node (YES at Step S205), the backup path route calculating unit 13d selects an add node at which a working path is not added as a connection node from a pair of add nodes in a next ring (Step S206). More specifically, from two nodes connected to the local ring in a neighboring ring on the side of a merge node, a node other than one that is first passed through by a working path is selected as a connection node. The backup path route calculating unit 13d calculates a route from the local node to the connection node (Step S207). The backup path setting message transmitting unit 13e generates a forward-direction backup path setting message for setting a backup path according to the route, and transmits the forward-direction backup path setting message to the connection node (Step S208).

If the local node is not a branch node (NO at Step 205), the node type determining unit 13c performs a merge node determining process described in detail below and determines whether the local node is a merge node (Step S209). If the local node is a merge node (YES at Step S210), the backup path route calculating unit 13d selects an add node at which a working path is not added as a connection node from a pair of add nodes in the local ring (Step S211). More specifically, a node other than one that is first passed through by a working path is selected as a connection node from two nodes in the local ring connected to the ring on the side of a branch node.

If the local node is not a connection node (NO at Step 212), the backup path route calculating unit 13d calculates a route from the local node to the connection node (Step S213). The backup path setting message transmitting unit 13e generates a reverse-direction backup path setting message for setting a backup path according to the route, and transmits the reverse-direction backup path setting message to the connection node (Step S214).

If the local node is neither a branch node nor a merge node (NO at Step S205 and NO at Step S210), or if the local node is a merge node and a connection node (YES at Step S210 and YES at Step S212), the working path setting process is terminated without setting a backup path.

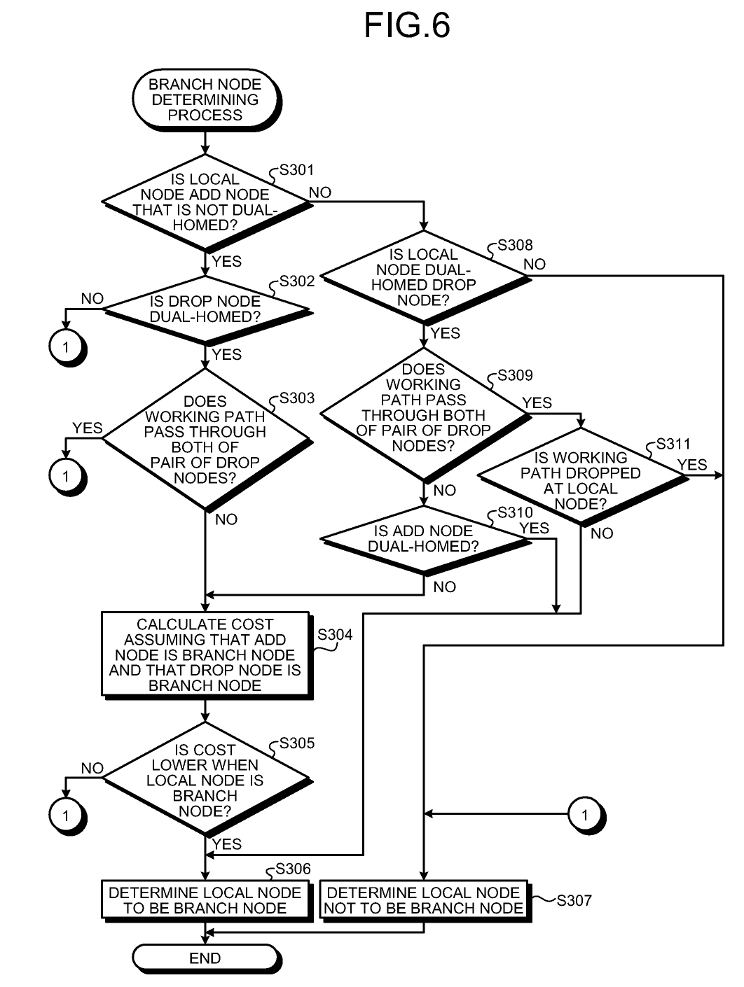

FIG. 6 is a detailed flowchart of the branch node determining process. In FIG. 6, whether the local node is a branch node is determined according to the restrictions of BLSR is illustrated. In the descriptions below, if rings are connected via two routes, it is referred to as “dual-homed”.

If the local node is an add node that is not dual-homed (YES at Step S301), if drop nodes in the local ring are dual-homed (YES at Step S302), and if the working path does not pass through both of two drop nodes (NO at Step S303), according to the restrictions of BLSR, either a drop node at which the working path is not dropped or the local node may be a branch node. Then, the node type determining unit 13c calculates a communication cost assuming each of the nodes is a branch node (Step S304). If the cost is lower when the local node is a branch node (YES at Step S305), the local node is determined to be a branch node (Step S306).

Similarly, if the local node is a dual-homed drop node (NO at Step S301 and YES at Step S308), if the working path does not pass through both of two drop nodes (NO at Step S309), and if an add node in the local ring is not dual-homed (NO at Step S310), according to the restriction of BLSR, either an add node or the local node may be a branch node. Then, the node type determining unit 13c calculates a communication cost assuming each of the nodes is a branch node (Step S304). If the cost is lower when the local node is a branch node (YES at Step S305), the local node is determined to be a branch node (Step S306).

If the local node is a dual-homed drop node (NO at Step S301 and YES at Step S308), if the working path does not pass through both of two drop nodes (NO at Step S309), and if add nodes in the local ring are dual-homed (YES at Step S310), according to the restrictions of BLSR, only the local node can be a branch node. Then, the node type determining unit 13c determines that the local node is a branch node (Step S306).

Similarly, if the local node is a dual-homed drop node (NO at Step S301 and YES at Step S308), if the working path passes through both of two drop nodes (YES at Step S309), and if the working path is not dropped at the local node (NO at Step S311), according to the restrictions of BLSR, only the local node can be a branch node. Then, the node type determining unit 13c determines that the local node is a branch node (Step S306).

In other cases, the node type determining unit 13c does not determine that the local node is a branch node (Step S307).

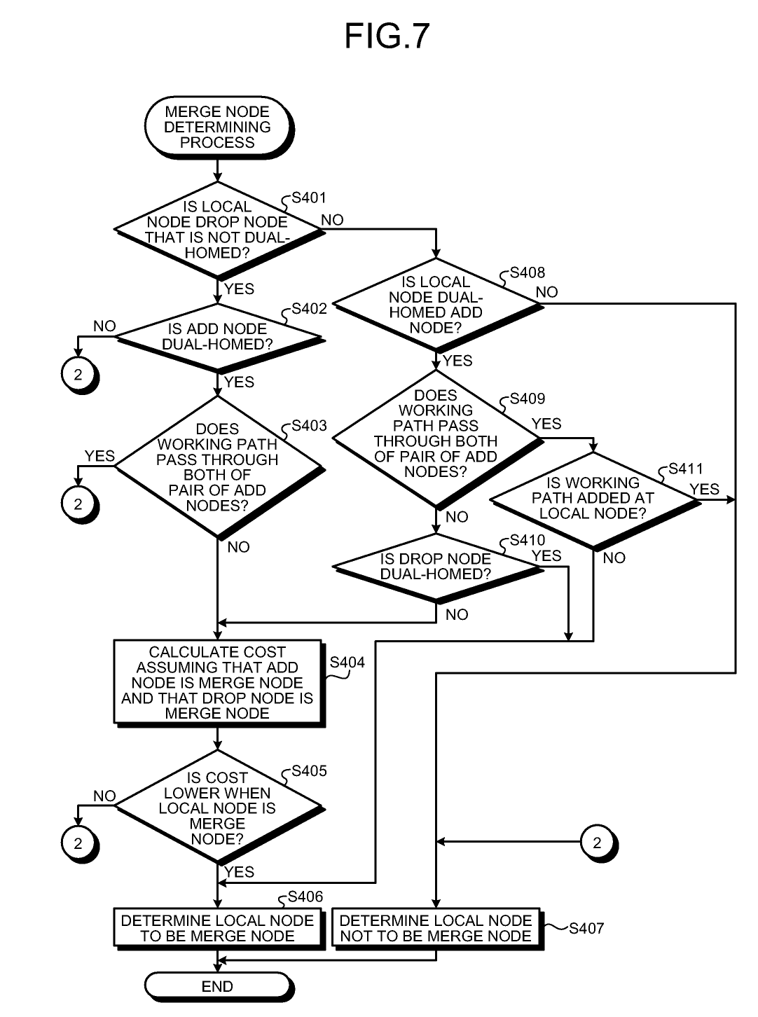

FIG. 7 is a detailed flowchart of the merge node determining process. In FIG. 7, whether the local node is a merge node is determined according to the restrictions of BLSR.

If the local node is a drop node that is not dual-homed (YES at Step S401), if the add nodes in the local ring are dual-homed (YES at Step S402), and if the working path does not pass through both of two add nodes (NO at Step S403), according to the restrictions of BLSR, either an add node at which the working path is not added or the local node may be a merge node. Then, the node type determining unit 13c calculates a communication cost assuming each of the nodes is a merge node (Step S404). If the cost is lower when the local node is a merge node, (YES at Step S405), the local node is determined to be a merge node (Step S406).

Similarly, if the local node is a dual-homed add node (NO at Step S401 and YES at Step S408), if the working path does not pass through both of two add nodes (NO at Step S409), and if a drop node in the local ring is not dual-homed (NO at Step S410), according to the restrictions of BLSR, either the drop node or the local node may be a merge node. Then, the node type determining unit 13c calculates a communication cost assuming each of the nodes is a merge node (Step S404). If the cost is lower when the local node is a merge node (YES at Step S405), the local node is determined to be a merge node (Step S406).

If the local node is a dual-homed add node (NO at Step S401 and YES at Step S408), if the working path does not pass through both of two add nodes (NO at Step S409), and if drop nodes in the local ring are dual homed (YES at Step S410), according to the restrictions of BLSR, only the local node can be a merge node. Then, the node type determining unit 13c determines that the local node is a merge node (Step S406).

Similarly, if the local node is a dual-homed add node (NO at Step S401 and YES at Step S408), if the working path passes through both of two add nodes (YES at Step S409), and if the working path is not added at the local node (NO at Step S411), according to the restrictions of BLSR, only the local node can be a merge node. Then, the node type determining unit 13c determines that the local node is a merge node (Step S406).

In other cases, the node type determining unit 13c does not determine that the local node is a merge node (Step S407).

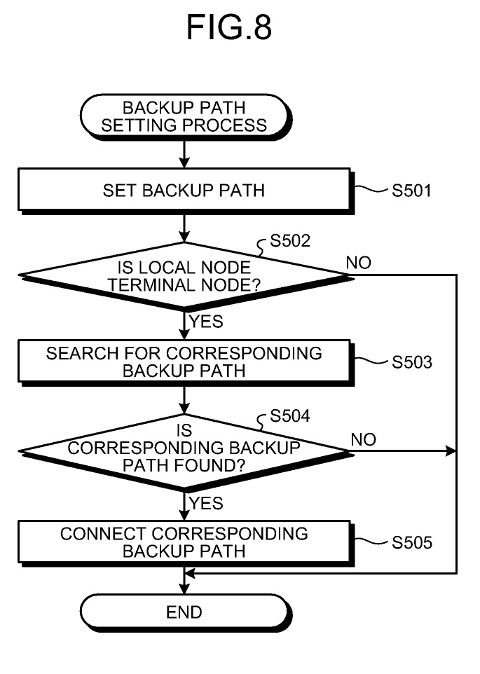

FIG. 8 is a detailed flowchart of the backup path setting process. As depicted in FIG. 8, when the transmitting apparatus 10 receives a backup path setting message, the backup path setting unit 13a sets a backup path in the forward direction or in the reverse direction according to a setting in the backup path setting message (Step S501). If the local node is a terminal node in the backup path that is set in the backup path setting message, in other words, if the local node is a connection node (YES at Step S502), a corresponding backup path is searched for (Step S503). If a corresponding backup path is found (YES at Step S504), the backup path newly set and the backup path found are connected to each other (Step S505).

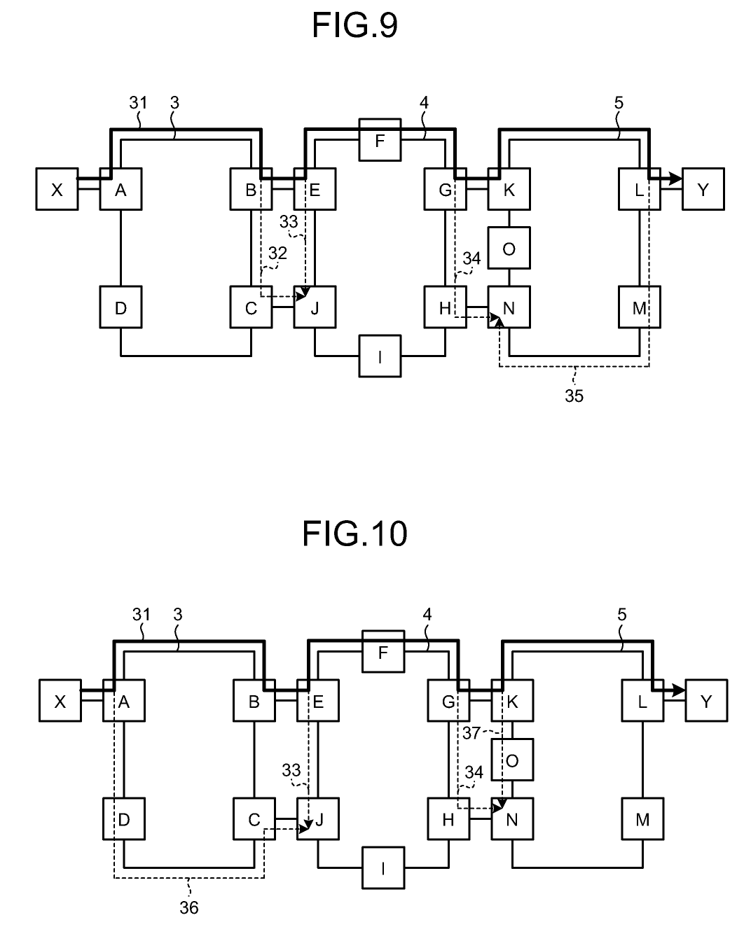

Described below is specific examples of path setting. FIG. 9 is an example of working path setting and backup path setting. A network depicted in FIG. 9 is configured such that a ring 3 composed of the nodes A to D, a ring 4 composed of the nodes E to J, and the ring 5 composed of the nodes K to O are connected to each other therein. Connection between the rings 3 and 4 is established by a route between the nodes B and E and a route between the nodes C and J. Connection between the ring 4 and a ring 5 is established by a route between the nodes G and K and a route between the nodes H and N. It is assumed that each node corresponds to the transmitting apparatus 10 depicted in FIG. 1, and each of the rings is a BLSR ring.

In the example of FIG. 9, a working path 31 having a route “X-A-B-E-F-G-K-L-Y” is set between a node X connected to the node A and a node Y connected to the node L. In the example, in the ring 3, the node B determines that the local node is a branch node, because the local node is a dual-homed drop node (NO at Step S301 and YES at Step S308), the working path does not pass through both of the two drop nodes (NO at Step S309), and an add node in the local ring is not dual-homed (NO at Step S310). Then, the node B transmits a forward-direction backup path setting message 32 to a connection node or the node J.

In the ring 4, the node E determines that the local node is a merge node, because the local node is a dual-homed add node (NO at Step S401 and YES at Step S408), the working path does not pass through both of the two add nodes (NO at Step S409), and the drop nodes in the local ring are dual-homed (YES at Step S410). Then, the node E transmits a reverse-direction backup path setting message 33 to the connection node or the node J. As a result that the two backup paths are connected to each other at the node J, a backup path is set via the route between the nodes “C and J”.

In the ring 4, the node G determines that the local node is a branch node, because the local node is a dual-homed drop node (NO at Step S301 and YES at Step S308), the working path does not pass through both of the two drop nodes (NO at Step S309), and the add nodes in the local ring are dual-homed (YES at Step S310). Then, the node G transmits a forward-direction backup path setting message 34 to a connection node or the node N.

In the ring 5, the node L determines that the local node is a merge node, because the local node is a drop node that is not dual-homed (YES at Step S401), the add nodes in the local ring are dual-homed (YES at Step S402), and the working path does not pass through both of the two add nodes (NO at Step S403). Then, the node L transmits a reverse-direction backup path setting message 35 to the connection node or the node N. As a result of that the two backup paths are connected to each other at the node N, a backup path is set via the route between the nodes “H and N”.

In the example depicted in FIG. 9, the node A, instead of the node B, can be a branch node in the ring 3 depending on condition of communication cost, because the local node is an add node that is not dual-homed (YES at Step S301), the drop nodes in the local ring are dual-homed (YES at Step S302), and the working path does not pass through both of the two drop nodes (NO at Step S303). If the node A is determined to be a branch node, as depicted in FIG. 10, the node A transmits a forward-direction backup path setting message 36 to the connection node or the node J.

In the example of FIG. 9, the node K, instead of the node L, can also be a merge node in the ring 3 depending on condition of communication cost, because the local node is a dual-homed add node (NO at Step S401 and YES at Step S408), the working path does not pass through both of the two add nodes (NO at Step S409), and a drop node in the local ring is not dual-homed (NO at Step S410). If the node K is determined to be a merge node, as depicted in FIG. 10, the node K transmits a reverse-direction backup path setting message 37 to the connection node or the node N.

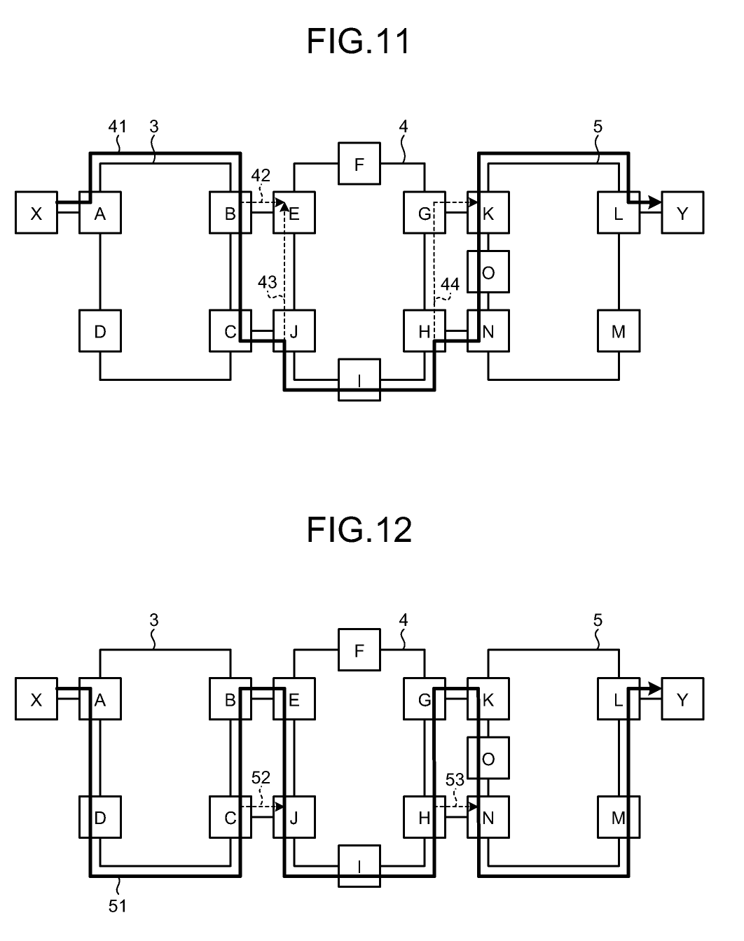

FIG. 11 is an example of backup path setting in the network depicted in FIG. 9 in which a working path 41 having a route “X-A-B-C-J-I-H-N-O-K-L-Y” is set. In the example, in the ring 3, the node B determines that the local node is a branch node, because the local node is a dual-homed drop node (NO at Step S301 and YES at Step S308), the working path passes through both of the two drop nodes (YES at Step S309), and the working path is not dropped at the local node (NO at Step S311). Then, the node B transmits a forward-direction backup path setting message 42 to a connection node or the node E.

In the ring 4, the node J determines that the local node is a merge node, because the local node is a dual-homed add node (NO at Step S401 and YES at Step S408), the working path does not pass through both of the two add nodes (NO at Step S409), and the drop nodes in the local ring are dual-homed (YES at Step S410). Then, the node J transmits a reverse-direction backup path setting message 43 to the connection node or the node E. As a result of that the two backup paths are connected at the node E, a backup path is set via the route between the nodes “B and E”.

In the ring 4, the node H determines that the local node is a branch node, because the local node is a dual-homed drop node (NO at Step S301 and YES at Step S308), the working path does not pass through both of the two drop nodes (NO at Step S309), and the add nodes in the local ring are dual-homed (YES at Step S310). Then, the node H transmits a forward-direction backup path setting message 44 to a connection node or the node K.

In the ring 5, the node K determines that the local node is a merge node, because the local node is a dual-homed add node (NO at Step S401 and YES at Step S408), the working path passes through both of the two add nodes (YES at Step S409), and the working path is not added at the local node (NO at Step S411). Then, because the local node is a connection node, the node K does not transmit a reverse-direction backup path setting message. A backup path via the route between the nodes “G and K”, however, is set by the backup path setting message 44.

FIG. 12 is an example of backup path setting in the network depicted in FIG. 9 in which a working path 51 having a route “X-A-D-C-B-E-J-I-H-G-K-O-N-M-L-Y”is set. In the example, in the ring 3, the node C determines that the local node is a branch node, because the local node is a dual-homed drop node (NO at Step S301 and YES at Step S308), the working path passes through both of the two drop nodes (YES at Step S309), and the working path is not dropped at the local node (NO at Step S311). Then, the node C transmits a forward-direction backup path setting message 52 to a connection node or the node J.

In the ring 4, the node J determines that the local node is a merge node, because the local node is a dual-homed add node (NO at Step S401 and YES at Step S408), the working path passes through both of the two add nodes (YES at Step S409), and the working path is not added at the local node (NO at Step S411). Then, because the local node is a connection node, the node J does not transmit a reverse-direction backup path setting message. A backup path via the route between the nodes “C and i”, however, is set by the backup path setting message 52.

In the ring 4, the node H determines that the local node is a branch node, because the local node is a dual-homed drop node (NO at Step S301 and YES at Step S308), the working path passes through both of the two drop nodes (YES at Step S309), and the working path is not dropped at the local node (NO at Step S311). Then, the node H transmits a forward-direction backup path setting message 53 to a connection node or the node N.

In the ring 5, the node N determines that the local node is a merge node, because the local node is a dual-homed add node (NO at Step S401 and YES at Step S408), the working path passes through both of the two add nodes (YES at Step S409), and the working path is not added at the local node (NO at Step S411). Then, because the local node is a connection node, the node N does not transmit a reverse-direction backup path setting message. A backup path is set via the route between the nodes “H and N”, however, is set by the backup path setting message 53.

Thus, according to the present embodiment, branch and merge nodes each transmit a backup path setting message to a connection node, i.e., a node on a connection section between rings, and then two paths specified by the backup path setting messages are connected to each other at the connection node to establish a backup path. Therefore, without detailed configuration information about the neighboring ring, the branch and merge nodes can set a backup path autonomously from less information, i.e., information about nodes that constitute the local ring and about a node on a connection section with the neighboring ring.

In the above embodiment, rings in a network are described as being connected via two routes. However, rings in a network can also be connected via three routes. In a network in which rings are connected via three routes, there may be two or more connection nodes. Then, for example, by selecting a connection node with the lowest cost, forward-direction and reverse-direction backup path setting messages may be transmitted to the connection node. In this case, for example, information about a connection node selected by a branch node may be transmitted to a merge node with a working path setting message. With this, the merge node can select the same connection node based on the information. Thus, the branch node and the merge node can select the same connection node.

Constituent elements, the expressions, or any arbitrary combination of the constituent elements of the transmitting apparatus can be applied with the same effect to a method, an apparatus, a system, a computer program, a recording medium, a data structure and so forth.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmitting apparatus in a network that is constituted of a plurality of rings connected via a plurality of routes, the transmitting apparatus comprising:
a node type determining unit that determines, on receipt of a working path setting message requesting to set a working path, whether the transmitting apparatus is any one of a branch node at which a backup path is branched off from the working path and a merge node at which the backup path merges into the working path, the backup path having a route other than a route of the working path that connects rings; and
a backup path setting message transmitting unit that transmits, when the node type determining unit determines that the transmitting apparatus is any one of a branch node and a merge node, a backup path setting message specifying a route from a local ring including the transmitting apparatus to a connection node connecting the local ring and a neighboring ring.

2. The transmitting apparatus according to claim 1, further comprising a backup path setting unit that, on receipt of a backup path setting message, when a corresponding backup path has already been set, connects a backup path requested to be set by the backup path setting message and the corresponding backup path.

3. The transmitting apparatus according to claim 2, wherein
the backup path setting message transmitted by the backup path setting message transmitting unit contains information about a working path corresponding to the backup path to be set, and
the backup path setting unit searches for the corresponding backup path based on the information about the working path.

4. The transmitting apparatus according to claim 1, wherein
the backup path setting message transmitting unit transmits, when the node type determining unit determines that the transmitting apparatus is a branch node, a forward-direction backup path setting message from upstream to downstream of the working path, and
the backup path setting message transmitting unit transmits, when the node type determining unit determines that the transmitting apparatus is a merge node, a reverse-direction backup path setting message from downstream to upstream of the working path.

5. The transmitting apparatus according to claim 1, wherein the connection node is a node, among nodes in a ring on a merge-node side connected to a ring on a branch-node side, other than a node through which the working path first passes.

6. The transmitting apparatus according to claim 1, wherein the connection node is a node, among nodes in a ring on a branch-node side connected to a ring on a merge-node side, other than a node through which the working path finally passes.

7. The transmitting apparatus according to claim 1, wherein, when the transmitting apparatus and other transmitting apparatus present in the local ring are possibly a branch node, the node type determining unit compares the transmitting apparatus with the other transmitting apparatus as a branch node in terms of cost, and determines, if cost is lower with the transmitting apparatus, that the transmitting apparatus is a branch node.

8. The transmitting apparatus according to claim 1, wherein, when the transmitting apparatus and other transmitting apparatus present in the local ring are possibly a merge node, the node type determining unit compares the transmitting apparatus with the other transmitting apparatus as a merge node in terms of cost, and determines, if cost is lower with the transmitting apparatus, that the transmitting apparatus is a merge node.

9. The transmitting apparatus according to claim 1, wherein, when the node type determining unit determines that the transmitting apparatus is a branch node, the backup path setting message transmitting unit adds, to the working path setting message corresponding to the backup path setting message, information about the connection node that is a destination of the backup path setting message.

10. The transmitting apparatus according to claim 9, wherein, when the node type determining unit determines that the transmitting apparatus is a merge node, if the working path setting message contains information about the connection node, the backup path setting message transmitting unit transmits the backup path setting message to the connection node.

11. The transmitting apparatus according to claim 1, wherein, when the node type determining unit determines that the transmitting apparatus is a branch node, if a plurality of connection nodes are present between the local ring and the neighboring ring, the backup path setting message transmitting unit selects a connection node with lowest cost, and transmits the backup path setting message to the selected connection node.

12. A path setting method applied to a transmitting apparatus in a network that is constituted of a plurality of rings connected via a plurality of routes, the path setting method comprising:
determining, on receipt of a working path setting message requesting to set a working path, whether the transmitting apparatus is any one of a branch node at which a backup path is branched off from the working path and a merge node at which the backup path merges into the working path, the backup path having a route other than a route of the working path that connects rings; and
transmitting, when the transmitting apparatus is determined to be any one of a branch node and a merge node at the determining, a backup path setting message specifying a route from a local ring including the transmitting apparatus to a connection node connecting the local ring and a neighboring ring.

13. The path setting method according to claim 12, further comprising connecting, on receipt of a backup path setting message, when a corresponding backup path to the backup path setting message has already been set, a backup path requested to be set by the backup path setting message and the corresponding backup path.

14. The path setting method according to claim 13, wherein
the backup path setting message transmitted at the transmitting contains information about a working path corresponding to the backup path to be set, and
the connecting includes searching for the corresponding backup path based on the information about the working path.

15. The path setting method according to claim 12, wherein the transmitting includes:
transmitting, when the transmitting apparatus is determined to be a branch node at the determining, a forward-direction backup path setting message from upstream to downstream of the working path, and
transmitting, when the transmitting apparatus is determined to be a merge node at the determining, a reverse-direction backup path setting message from downstream to upstream of the working path.

16. The path setting method according to claim 12, wherein the connection node is a node, among nodes in a ring on a merge-node side connected to a ring on a branch-node side, other than a node through which the working path first passes.

17. The path setting method according to claim 12, wherein the connection node is a node, among nodes in a ring on a branch-node side connected to a ring on a merge-node side, other than a node through which the working path finally passes.

18. The path setting method according to claim 12, wherein the determining includes comparing, when the transmitting apparatus and other transmitting apparatus present in the local ring are possibly a branch node, the transmitting apparatus with the other transmitting apparatus as a branch node in terms of cost, and determining, if cost is lower with the transmitting apparatus, that the transmitting apparatus is a branch node.

19. The path setting method according to claim 12, wherein the determining includes comparing, when the transmitting apparatus and other transmitting apparatus present in the local ring are possibly a merge node, the transmitting apparatus with the other transmitting apparatus as a merge node in terms of cost, and determining, if cost is lower with the transmitting apparatus, that the transmitting apparatus is a merge node.

20. The path setting method according to claim 12, wherein the transmitting includes adding, when the transmitting apparatus is determined to be a branch node at the determining, to the working path setting message corresponding to the backup path setting message, information about the connection node that is a destination of the backup path setting message.

21. The path setting method according to claim 20, wherein the transmitting includes transmitting, when the transmitting apparatus is determined to be a merge node at the determining, if the working path setting message contains information about the connection node, the backup path setting message to the connection node.

22. The path setting method according to claim 12, wherein the transmitting includes selecting, when the transmitting apparatus is determined to be a branch node, if a plurality of connection nodes are present between the local ring and the neighboring ring, a connection node with lowest cost, and transmitting the backup path setting message to the selected connection node.
